(19) United States
(12) Patent Application Publication
(10) Pub. No.: US 2017/0230649 A1
(43) Pub. Date: Aug. 10, 2017

(54) CALIBRATION OF HYBRID AUTO FOCUS (AF) IMAGING SYSTEMS

(71) Applicant: QUALCOMM Incorporated, San Diego, CA (US)

(72) Inventors: Micha Galor Gluskin, San Diego, CA (US); Jisoo Lee, San Diego, CA (US)

(21) Appl. No.: 15/017,303

(22) Filed: Feb. 5, 2016

(51) Int. Cl. H04N 17/00; G02B 7/09; H04N 5/232

(52) U.S. Cl. CPC H04N 17/002; H04N 5/23212; G02B 7/09

(57) ABSTRACT

Methods and apparatuses for calibration of hybrid auto focus (AF) imaging systems are disclosed. In one aspect, a method is operable by an imaging device including a hybrid auto focus (AF) system comprising a lens. The method may include capturing an image of a scene, determining that the image of the scene is out of focus, and estimating, via a first AF process of the hybrid AF system, an initial lens position at which the image is in focus in response to determining that the image is out of focus; moving the lens to the initial lens position. The method may also include determining, via a second AF process of the hybrid AF system, a final lens position in response to the movement of the lens to the initial lens position and calibrating the first AF processes based on the determined final lens position.

### TECHNICAL FIELD

The present application relates generally to digital image processing, and more specifically, to methods and systems for calibration of hybrid auto focus (AF) imaging systems.

### BACKGROUND

Imaging devices, such as digital cameras, may perform hybrid auto focus (AF) in order to increase AF speed. Such hybrid AF processes may include an initial coarse AF process that more quickly approaches the focal lens position than a fine AF process and the fine AF processes that more accurately reaches a final focal lens position than the coarse AF process. Hybrid AF processes may be calibrated during production of the imaging system. Production-time calibrations may be lengthy and the environmental conditions when performing the hybrid AF process may not match the environmental conditions of the production-time calibration. In this context, there remains a need for improvement in the reduction of hybrid AF system production time (i.e., shortening the calibration performed during production) and in the adaptability of the hybrid AF process to changing environmental conditions.

### SUMMARY

The systems, methods and devices of this disclosure each have several innovative aspects, no single one of which is solely responsible for the desirable attributes disclosed herein.

In one aspect, there is provided a method, operable by an imaging device including a hybrid auto focus (AF) system comprising a lens and configured to perform at least one of a first AF processor and a second AF process. The method can comprise capturing an image of a scene; determining that the image of the scene is out of focus; estimating, via the first AF process of the hybrid AF system, an initial lens position at which the image is in focus in response to determining that the image is out of focus; moving the lens to the initial lens position; determining, via the second AF process of the hybrid AF system, a final lens position in response to the movement of the lens to the initial lens position; and calibrating the first AF processes based on the determined final lens position.

In another aspect, there is provided an imaging device, comprising an image sensor; a lens; a hybrid auto focus (AF) system configured to perform a first AF process and a second AF process; at least one processor; and a memory storing computer-executable instructions for controlling the at least one processor to: capture an image of a scene; determine that the image of the scene is out of focus; estimate, via the first AF process of the hybrid AF system, an initial lens position at which the image is in focus in response to determining that the image is out of focus; move the lens to the initial lens position; determine, via the second AF process of the hybrid AF system, a final lens position in response to the movement of the lens to the initial lens position; and calibrate the first AF process based on the determined final lens position.

In yet another aspect, there is provided an apparatus comprising means for capturing an image of a scene; means for determining that the image of the scene is out of focus; means for estimating an initial lens position at which the image is in focus in response to determining that the image is out of focus; means for moving the lens to the initial lens position; means for determining a final lens position in response to the movement of the lens to the initial lens position; and means for calibrating the means for estimating based on the determined final lens position.

In still another aspect, there is provided a non-transitory computer readable storage medium having stored thereon instructions that, when executed, cause a processor of a device to: capture an image of a scene; determine that the image of the scene is out of focus; estimate, via the first AF process of the hybrid AF system, an initial lens position at which the image is in focus in response to determining that the image is out of focus; move the lens to the initial lens position; determine, via the second AF process of the hybrid AF system, a final lens position in response to the movement of the lens to the initial lens position; and calibrate the first AF processes based on the determined final lens position.

### BRIEF DESCRIPTION OF THE DRAWINGS

FIG. 1A illustrates an example of an apparatus (e.g., a mobile communication device) that includes an imaging system that can record images of a scene in accordance with aspects of this disclosure.

FIG. 1B is a block diagram illustrating an example of an imaging device in accordance with aspects of this disclosure.

FIG. 2 provides a graph illustrating an example of a hybrid AF process including coarse and fine searches.

FIG. 3 is graph illustrating an example of an auxiliary AF calibration curve.

FIG. 4 is a flowchart illustrating an example hybrid AF calibration process in accordance with aspects of this disclosure.

FIG. 5 is a graph illustrating an example calibration curve in accordance with aspects of this disclosure.

FIG. 6 is a graph illustrating another example calibration curve in accordance with aspects of this disclosure.

FIG. 7 is a flowchart illustrating an example method operable by an imaging device in accordance with aspects of this disclosure.

FIG. 8 is a flowchart illustrating another example method operable by an imaging device in accordance with aspects of this disclosure.

### DETAILED DESCRIPTION

Digital camera systems or other imaging devices may perform auto focus (AF) to move a lens module of an imaging device so that light captured from a scene is focused on an image sensor. One method for AF is contrast AF, which may be performed based on images captured by the imaging device. Contrast AF may involve determining a focal lens position by adjusting a lens position of the imaging device until a maximum contrast is detected in the captured image. Such contrast AF techniques may require small movements of the lens in order to reliably determine the focal lens position for a given scene.

There are a number of other AF techniques, which may require dedicated hardware, that compliment contrast AF. Such techniques may include, for example, time of flight AF (TOFAF), phase detection AF (PDAF), stereo AF (also referred to as dual camera instant AF (DCIAF)), structured light AF, ultrasound AF, and LIDAR AF. Certain AF techniques may actively measure the distance to an object within the scene and estimate a lens position at which the object will be in focus (e.g., a focal lens position) based on the measured distance. By estimating the focal lens position, the imaging device may quickly move to the estimated lens position, leading to a faster focus time. However, these AF techniques may not be as accurate as contrast AF techniques. For example, when these AF techniques are implemented and conform to certain design constraints, such as a cost, power, and/or footprint below a design threshold, these AF technologies may not be able to match the accuracy of contrast AF.

Such complimentary AF techniques (hereinafter referred to as auxiliary AF techniques) may be combined with contrast AF techniques to form a hybrid AF process. An auxiliary AF process may be performed to find an estimated focal lens position (e.g., an estimated initial lens position) and after moving the lens to the estimated focal lens position, the contrast AF process may be performed to determine an accurate final focal lens position.

The hybrid AF process of an imaging device may be calibrated during the production of the imaging device. This may include, for example, calibrating each imaging device based on a template imaging device such that each imaging device receives the same calibration settings. This template calibration may not take into account the manufacturing errors of each individual imaging device, leading to variations in the accuracy of the calibration between the imaging devices. Alternatively, each imaging device may be individually calibrated on the production line. Production line calibration of hybrid AF imaging devices is the current norm since template calibration is not typically reliable enough to provide satisfactory calibration of hybrid AF imaging devices. Such individual calibration may be time consuming, resulting in higher production costs. Furthermore, certain environmental conditions, such as the temperature of the imaging device, may affect the calibration settings. That is, when used at temperatures differing from the calibration temperatures, the calibration settings of the imaging device may no longer be sufficiently accurate. Accordingly, individual calibration may not be adaptable to the changing environmental conditions under which the imaging device is used.

The following detailed description is directed to certain specific embodiments. However, the described technology can be embodied in a multitude of different ways. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Further, the systems and methods described herein may be implemented on a variety of different computing devices that host a camera. These include mobile phones, tablets, dedicated cameras, portable computers, photo booths or kiosks, personal digital assistants, ultra-mobile personal computers, mobile internet devices, security cameras, action cameras, drone cameras, automotive cameras, body cameras, head mounted cameras, etc. They may use general purpose or special purpose computing system environments or configurations. Examples of computing systems, environments, and/or configurations that may be suitable for use with the described technology include, but are not limited to, personal computers (PCs), server computers, hand-held or laptop devices, multiprocessor systems, microprocessor-based systems, programmable consumer electronics, network PCs, minicomputers, mainframe computers, distributed computing environments that include any of the above systems or devices, and the like.

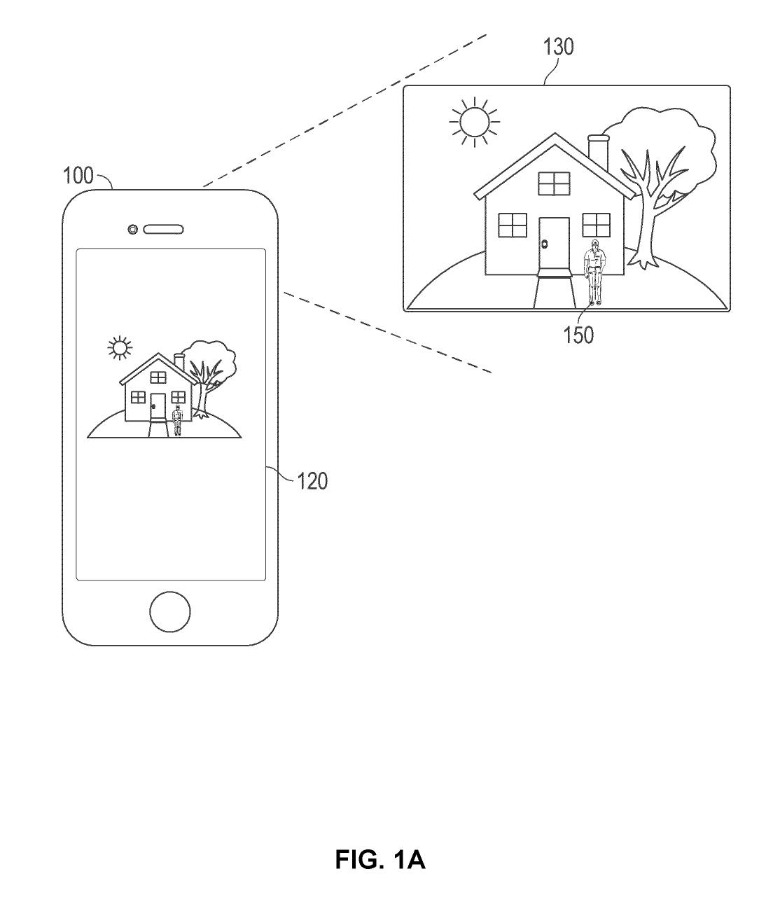

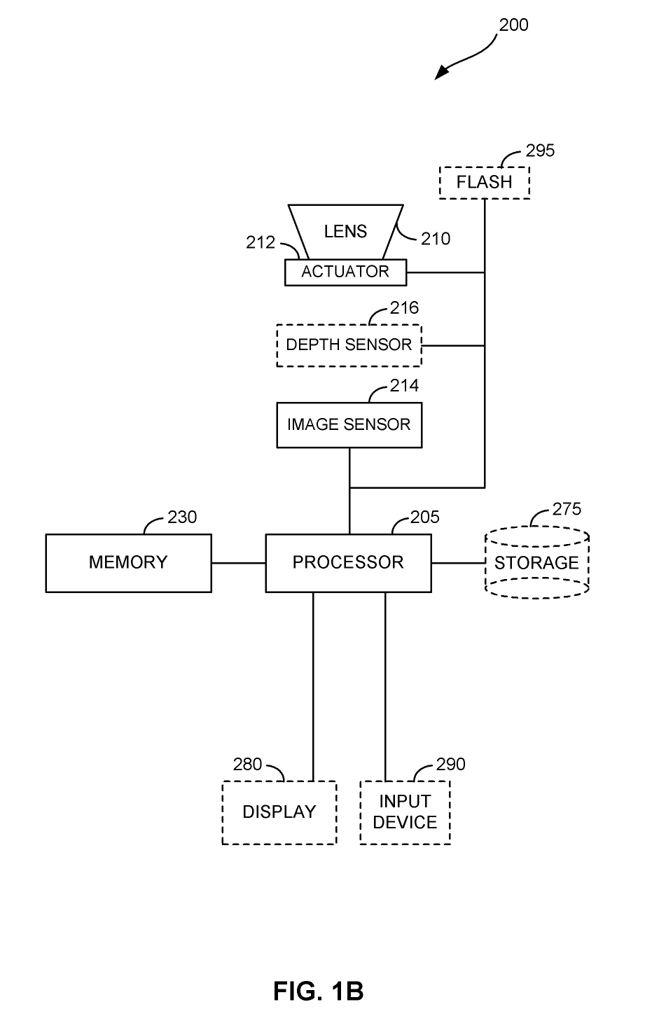

FIG. 1A illustrates an example of an apparatus (e.g., a mobile communication device) that includes an imaging system that can record images of a scene in accordance with aspects of this disclosure. The apparatus 100 includes a display 120. The apparatus 100 may also include a camera on the reverse side of the apparatus, which is not shown. The display 120 may display images captured within the field of view 130 of the camera. FIG. 1A shows an object 150 (e.g., a person) within the field of view 130 which may be captured by the camera. A processor within the apparatus 100 may perform calibration of a hybrid AF process based on the captured image of the scene.

The apparatus 100 may perform calibration of a hybrid AF process based on images captured by a user of the apparatus 100. In one aspect, the apparatus 100 may perform calibration based on images captured with hybrid AF processes performed during run-time (e.g., while in use by an end-user of the apparatus 100). Aspects of this disclosure may relate to techniques which can improve the calibration of the hybrid AF processes of the apparatus 100 compared to production line calibration.

FIG. 1B depicts a block diagram illustrating an example of an imaging device in accordance with aspects of this disclosure. The imaging device 200, also referred herein to interchangeably as a camera, may include a processor 205 operatively connected to an image sensor 214, an optional depth sensor 216, a lens 210, an actuator 212, a memory 230, an optional storage 275, an optional display 280, an optional input device 290, and an optional flash 295. In this example, the illustrated memory 230 may store instructions to configure processor 205 to perform functions relating to the imaging device 200. In this example, the memory 230 may include instructions for instructing the processor 205 to perform calibration of hybrid AF processes.

In an illustrative embodiment, light enters the lens 210 and is focused on the image sensor 214. In some embodiments, the lens 210 is part of a hybrid AF system which can include multiple lenses and adjustable optical elements and may be controllable by the processor 205. In one aspect, the image sensor 214 utilizes a charge coupled device (CCD). In another aspect, the image sensor 214 utilizes either a complementary metal-oxide semiconductor (CMOS) or CCD sensor. The lens 210 is coupled to the actuator 212 and may be moved by the actuator 212 relative to the image sensor 214. The movement of the lens 210 with respect to the image sensor 214 may affect the focus of a captured image. The actuator 212 is configured to move the lens 210 in a series of one or more lens movements during an AF operation, for example, adjusting the lens position to change the focus of an image. When the lens 210 reaches a boundary of its movement range, the lens 210 or actuator 212 may be referred to as saturated. In an illustrative embodiment, the actuator 212 is an open-loop voice coil motor (VCM) actuator. However, the lens 210 may be actuated by any method known in the art including closed-loop VCM, Micro-Electronic Mechanical System (MEMS), shape memory alloy (SMA), piezo-electric (PE), or liquid lens.

The depth sensor 216 is configured to estimate the depth of an object to be captured in an image by the imaging device 200. The depth sensor 216 may be configured to perform a depth estimation using any technique applicable to determining or estimating depth of an object or scene with respect to the imaging device 200, including AF techniques for estimating depth such as TOFAF, laser auto focus, or DCIAF, or other depth sensing technologies such as structured light sensors. Alternatively, the depth sensor 216 may be configured to perform a depth estimation based on a lens position determined by PDAF. The techniques may also be applied using depth or location information received by the imaging device 200 from or about an object within a scene. Depending on the AF technique employed, the depth sensor 216 may be integrated into other components of the imaging device 200. For example, when using PDAF, the image sensor 214 may include specialized phase detection pixels which may be partially masked. These phase detection pixels may be formed as pairs referred to as “left” and “right” phase detection pixels.

The display 280 is configured to display images captured via the lens 210 and the image sensor 214 and may also be utilized to implement configuration functions of the imaging device 200. In one implementation, the display 280 may be configured to display one or more regions of a captured image selected by a user, via an input device 290, of the imaging device 200. In some embodiments, the imaging device 200 may not include the display 280.

The input device 290 may take on many forms depending on the implementation. In some implementations, the input device 290 may be integrated with the display 280 so as to form a touch screen display. In other implementations, the input device 290 may include separate keys or buttons on the imaging device 200. These keys or buttons may provide input for navigation of a menu that is displayed on the display 280. In other implementations, the input device 290 may be an input port. For example, the input device 290 may provide for operative coupling of another device to the imaging device 200. The imaging device 200 may then receive input from an attached keyboard or mouse via the input device 290. In still other embodiments, the input device 290 may be remote from and communicate with the imaging device 200 over a communication network, e.g., a wireless network.

The memory 230 may be utilized by the processor 205 to store data dynamically created during operation of the imaging device 200. In some instances, the memory 230 may include a separate working memory in which to store the dynamically created data. For example, instructions stored in the memory 230 may be stored in the working memory when executed by the processor 205. The working memory may also store dynamic run time data, such as stack or heap data utilized by programs executing on processor 205. The storage 275 may be utilized to store data created by the imaging device 200. For example, images captured via image sensor 214 may be stored on storage 275. Like the input device 290, the storage 275 may also be located remotely, i.e., not integral with the imaging device 200, and may receive captured images via the communication network.

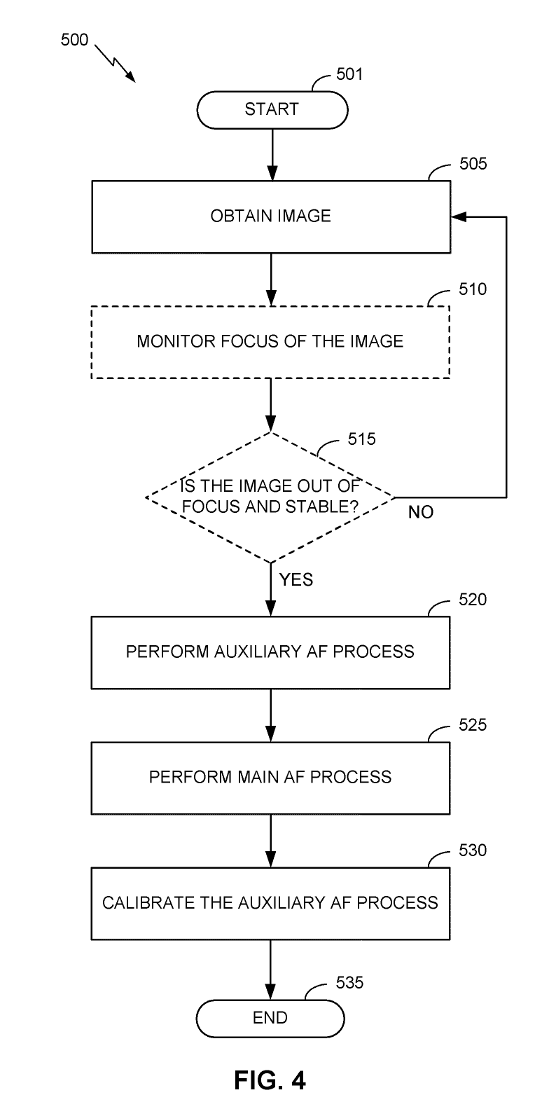

The memory 230 may be considered a computer readable medium and stores instructions for instructing the processor 205 to perform various functions in accordance with this disclosure. For example, in some aspects, memory 230 may be configured to store instructions that cause the processor 205 to perform method 500, method 800, method 900, or portion(s) thereof, as described below and as illustrated in FIGS. 4, 7 and 8.

In one implementation, the instructions stored in the memory 230 may include instructions that, when executed, cause the processor 205 to determine lens positions in a range of lens positions of the lens 210 that may include a desired lens position for capturing an image. The determined lens positions may not include every possible lens position within a range of lens positions, but may include only a subset of the possible lens positions within the range of lens positions. The determined lens positions may be separated by a step size of one or more possible lens positions between determined lens positions. For example, the determined lens positions can include a first lens position at one end of the range of lens positions, the first lens position representing a first focusing distance, and a second lens position at the other end of the range of lens positions, the second lens position representing a second focusing distance. The determined lens positions may further include one or more intermediate lens positions, each intermediate lens position representing a focusing distance between the first and second focusing distances, where the determined lens positions are separated by a step size of one or more possible lens positions between the determined lens positions in the first range of lens positions. In an illustrative embodiment, the processor 205 may determine lens positions in a range of lens positions based at least in part on an estimation of the depth of an object.

The instructions may also, when executed, cause the processor 205 to determine or generate focus values for images captured at one or more lens positions within the range of lens positions. The desired lens position for capturing an image may be a lens position having a maximum focus value. The instructions may also, when executed, cause the processor 205 to determine or generate a focus value curve or data representative of a focus value curve based on the determined or generated focus values. The instructions may also, when executed, cause the processer 205 to determine lens positions in a search range of lens positions based at least in part on generated focus values or a focus value curve or data representative of a focus value curve based on a previous search range of lens positions.

### Hybrid AF Techniques

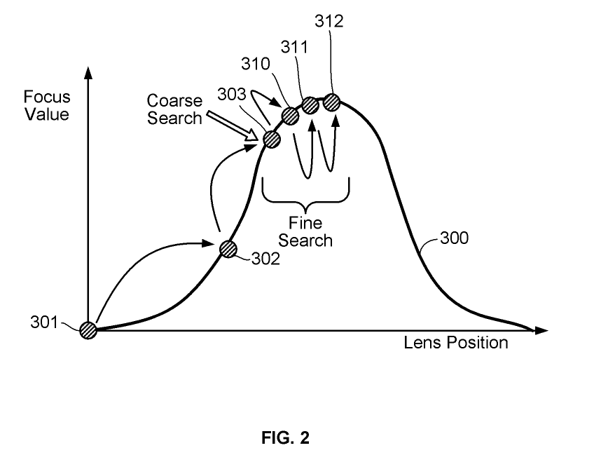

FIG. 2 provides a graph illustrating an example of a hybrid AF process including coarse and fine searches. The graph of FIG. 2 includes a curve 300 representing a focus value (e.g., a contrast value obtained using a contrast AF technique) for a captured image according to various lens positions. The hybrid AF process may include a coarse search performed by an auxiliary AF process and a fine search performed by a main AF process. The coarse search may include moving the lens to lens positions 301, 302, and 303. However, the lens positions 301 to 303 illustrated in FIG. 2 are merely examples and in other implementations, the auxiliary AF process may move directly from the start lens position 301 to an estimated initial lens position, such as lens position 303.

Once the lens has moved to the estimated initial lens position 303, the hybrid AF process may include performing the main AF process in order to perform the fine search. The fine search may include a contrast AF process where the lens position is moved from the estimated initial lens position 303 to lens positions 310, 311, and 312. The main AF process may determine that the maximum contrast occurs at lens position 312, and thus, the hybrid AF process may be completed by terminating the movement of the lens at a final lens position 312. Due to the movement of the lens to the initial lens position by the auxiliary AF process, the hybrid AF process may be more efficient than a main AF process performed alone. For example, a contrast AF process may initially overshoot the final lens position 312 and then return to the final lens position 312 via a number of additional lens movements in a process call focus hunting. This type of focus hunting may be prevented in the hybrid AF process due to the initial movement of the lens to the estimated initial lens position.

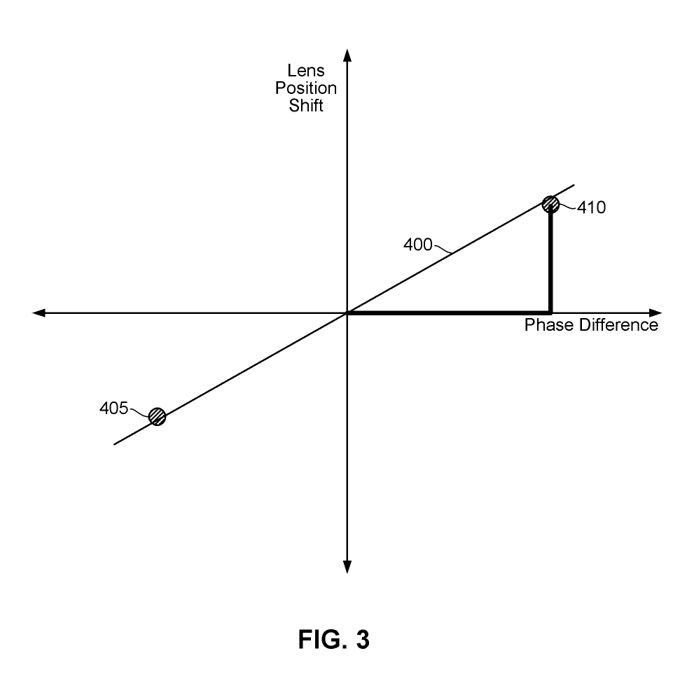

The calibration of the auxiliary AF process will now be discussed in connection with FIG. 3. In the description that follows, an implementation where a PDAF technique is used in the auxiliary AF process will be described. However, the disclosed calibration techniques may be performed by any auxiliary AF process that relates a measured optical parameter to a shift in lens position resulting in an estimated focal lens position.

FIG. 3 is graph illustrating an example of a PDAF calibration curve. The calibration curve 400 relates a measured phase difference to an estimated lens position shift that would result in a captured image being in focus. The lens position shift may be a value by which to shift the current lens position to obtain an estimated initial lens position. The measured phased difference may be the phase difference measured between left and right phase detection pixels of the image sensor 214. As discussed above, the calibration curve 400 may be determined at production time. The phase difference may be related to the lens position shift by the following equation:

LP=PD*K (1)

where LP is the lens position shift, PD is the measured phase difference, and K is a calibration coefficient.

The PDAF process may thus determine a lens position shift by multiplying the measured phase difference by the coefficient K. An estimated initial lens position may be the current lens position shifted by the lens position shift value. The calibration curve 400, and thus the coefficient K, may vary from device to device and based on environmental conditions such as temperature. Accordingly, each imaging device 200 may be require individual calibration for an accurate estimation of lens position shift. When calibrated at production time, the calibration coefficient may be stored in the memory 230 or in a specialized one-time programmable (OTP) memory.

### Calibration of Auxiliary AF Process

FIG. 4 is a flowchart illustrating an example hybrid AF calibration process in accordance with aspects of this disclosure. The steps illustrated in FIG. 4 may be performed by an imaging device 200 or component(s) thereof. For example, the method 500 may be performed by a processor 205 of the imaging device 200. For convenience, the method 500 is described as performed by the processor 205 of the imaging device 200.

The method 500 starts at block 501. At block 505, the processor 205 obtains an image of a scene from an image sensor 214. The image may be obtained by the image sensor 214 capturing an image through a lens 210. At optional block 510, the processor 205 monitors the focus of the image. For example, at optional block 515, the processor 205 may determine whether the image is out of focus and whether the focus of the image is stable with respect to the focus of previously obtained images. When the image is in focus and/or is unstable, the method 500 returns to block 505 where the processor 205 obtains another image of the scene. Optional blocks 510 and 515 may be performed during a continuous AF implementation. Optional blocks 510 and 515 may be skipped when performing a triggered or single AF process (e.g., after receiving input from a user requiring AF of a scene such as a command to capture an image).

When the image is out of focus and stable or after skipping blocks 510 and 515, the method 500 proceeds to block 520, where the processor 205 performs an auxiliary AF process, which may be a coarse focus search. The auxiliary AF process may include the processor 205 determining a phase difference based on signals received from left and right phase detection pixels of the image sensor 214. The auxiliary AF process may also include the processor 205 estimating an initial lens position by shifting a current lens position by the product of the measured phase difference and a coefficient K. When the calibration curve or method is not a linear curve as shown in FIG. 3, the processor 205 may estimate the initial lens position by another method as will be described in detail below.

At block 525, the processor performs a main AF process, which may be a fine focus search. The main AF process may include the processor 205 performing a contrast AF process including determining a final lens position at which a captured image is in focus. At block 530, the processor 205 may calibrate the auxiliary AF process based on the final lens position determined during the main AF process. The method 500 ends at block 535. Although not illustrated in FIG. 4, the method may loop back to the start block 501 after the method 500 has ended at block 535 in order to perform a continuous AF process.

Aspects of this disclosure are related to the calibration of an auxiliary AF process based on the results of a main AF process. As described in connection with FIGS. 2 to 4, an auxiliary AF process may allow a hybrid AF process to quickly approach a focal lens position via an auxiliary AF process and determine a final lens position using a more accurate main AF process (e.g., a contrast AF process). Since the auxiliary AF process allows the hybrid AF process to more quickly reach a final lens position, any improvement to the accuracy of the auxiliary AF process reduces the time required for the contrast AF process, and thus, the overall time required for performing the hybrid AF process. As such, aspects of this disclosure relate to improving the calibration of the auxiliary AF process.

One method for calibrating the auxiliary AF process may include comparing the final lens position determined by the main AF process to the estimated initial lens position determined by the auxiliary AF process. When the focal lens position does not change or is substantially the same during both of the auxiliary and main AF processes, the final lens position may indicate an ideal estimate for the auxiliary AF process. For example, the final lens position may be a lens position at which the image captured during the auxiliary AF process would be in focus, and thus, may be used to calibrate the estimation performed by the auxiliary AF process. Accordingly, a plurality of determined final lens positions may be used to calibrate the coefficient K based on the corresponding measured phase differences.

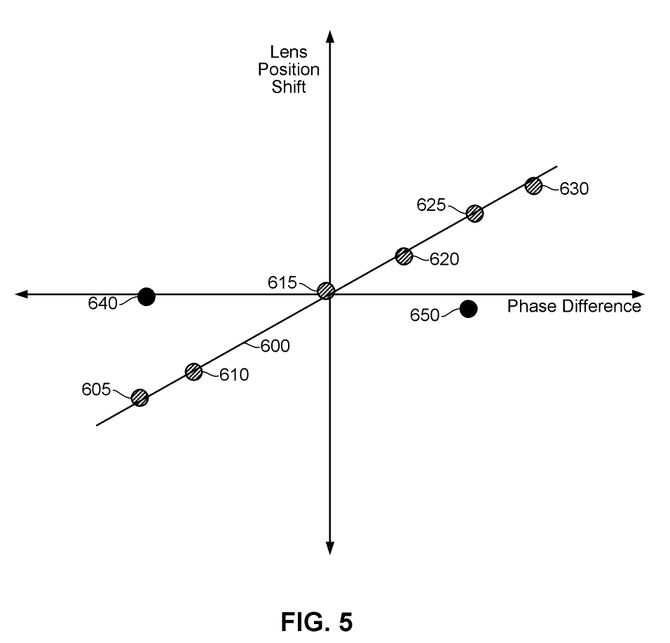

FIG. 5 is a graph illustrating an example calibration curve in accordance with aspects of this disclosure. FIG. 5 includes a plurality of lens position shift values 605, 610, 615, 620, 625, 630, 640, and 650 which are plotted against the corresponding measured phase differences. The lens positions shift values may be the difference between a starting lens position and a final lens position as determined by a main AF technique. A calibration curve 600 may be determined based on the lens position shift values 605 to 630. For example, the coefficient K of the calibration curve 600 may be determined based on a linear regression of the lens position shift values 605 to 630. Lens position shift values 640 and 650 may be determined as outliers, and thus, may be removed from the samples used in the determination of the coefficient K. In one implementation, a random sample consensus (RANSAC) technique may be used to determine lens position shift values 640 and 650 as outliers from the set of lens position shift values 605 to 650. Since the outlier lens position shift values 640 and 650 may be due to circumstances that are not representative of the accuracy of the auxiliary AF process (e.g., the focal lens position may have changed between the auxiliary AF process and the main AF process), the calibration curve 600 and the coefficient K may be more accurately calculated by omitting the outlier lens position shift values 640 and 650 from the calibration of the coefficient K. In other implementations, any other outlier rejection strategy may be used to determine the outlier lens position shift values 640 and 650.

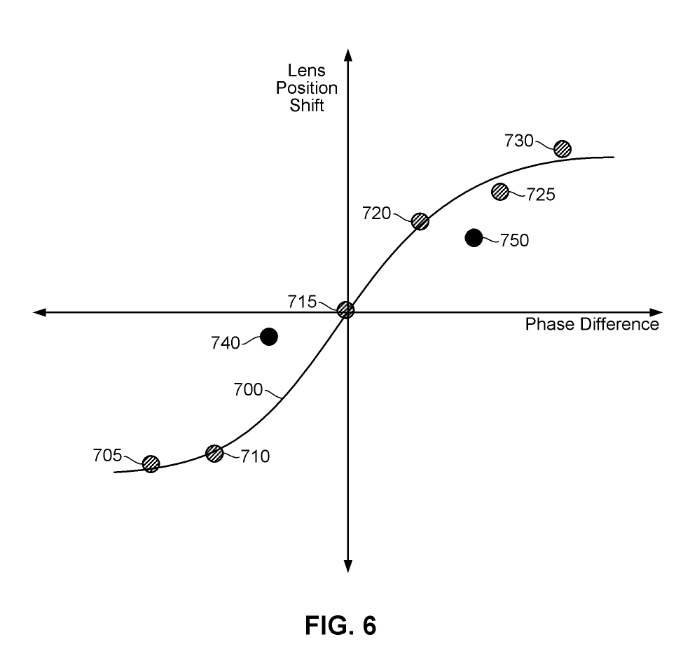

FIG. 6 is a graph illustrating another example calibration curve in accordance with aspects of this disclosure. FIG. 6 includes a plurality of lens position shift values 705, 710, 715, 720, 725, 730, 740, and 750 which are plotted against the corresponding phase differences. A calibration curve 700 may be determined based on the lens position shift values 705 to 730. The calibration curve 700 may be fit to a higher-order curve than the linear calibration curve 600 of FIG. 5. Accordingly, the relationship between the lens position shift and the phase difference may be calculated based on the function describing the calibration curve 700.

Due to the run-time or adaptive calibration of the calibration curve 700 described in this disclosure, it may be feasible to fit the sample lens position shift values 705 to 730 to the higher-order curve 700. However, when calibration is performed during production of the imaging device 200, the time requirements to perform higher-order calibration may be prohibitive. For example, the time and cost requirements for capturing multiple images at different focal distances and lens positions during production of an imaging device 200 may be too great to incorporate into imaging device 200 production.

In other implementations, the calibration of the auxiliary AF process may be represented by a 2 dimensional (2D) array. This implementation may be performed in order to take into account multiple inputs. For example, a correction value (e.g., lens position shift value) may be dependent upon the current lens position. Table 1 below illustrates an exemplary 2D array that may be used to relate a measured phase difference and a current lens position to a correction value. When the phase difference falls between entries in the 2D array, a lens position shift may be interpolated based on nearby entries in the 2D array. In Table 1, the left column represent phase difference values, the top row represents lens positions, and the remaining entries are correction values. Although Table 1 illustrates the storage of the lens position shift values in the 2D array, other implementations may include the storage of the final lens position data instead of the lens position shift values.

TABLE 1

Lens Position

| Phase Difference | 100 | 200 | 300 | 400 |
|---|---|---|---|---|
| 2 | 20 | 40 | 44 | 50 |
| 1 | 10 | 14 | 18 | 20 |
| 0 | 2 | −1 | 3 | 6 |
| −1 | −10 | −10 | −13 | −15 |
| −2 | −22 | −25 | −25 | −26 |

In certain implementations, other measurements may be used as inputs to determine the correction values. For example, the imaging device 200 may include a thermometer (not illustrated) to determine the operating temperature of the imaging device 200. In other embodiments, the imaging device 200 may obtain temperature information from an external source, for example, the imaging device 200 may obtain temperature information from a weather service via the internet based on location data from a GPS device, a cellular location device, or a Wi-Fi location device. The calibration process may use the measured temperature as an additional input in determining the correction values. This may be implemented via, for example, a 3D array with phase difference, lens position, and temperature as inputs.

### Example Flowcharts for Calibration of Hybrid AF Imaging Devices

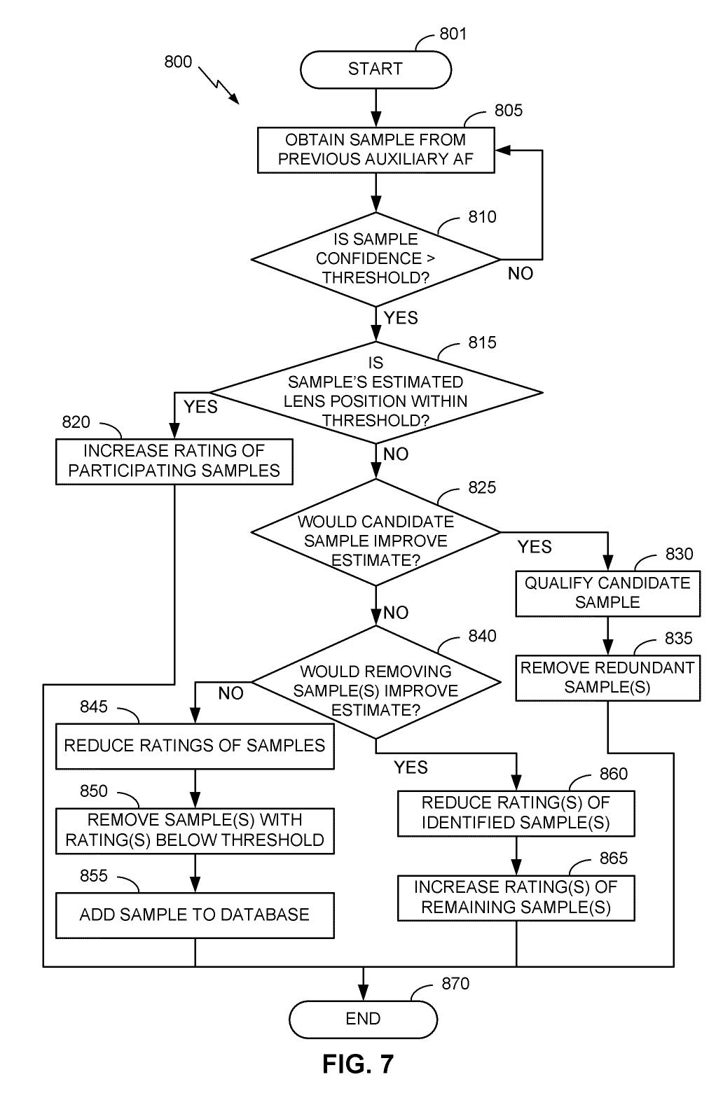

An exemplary implementation of this disclosure will now be described in the context of a hybrid AF calibration method. FIG. 7 is a flowchart illustrating an example method 800 operable by an imaging device 200, or component(s) thereof, for calibration of hybrid AF in accordance with aspects of this disclosure. For example, the steps of method 800 illustrated in FIG. 7 may be performed by a processor 205 of the imaging device 200. For convenience, method 800 is described as performed by the processor 205 of the imaging device 200. The method 800 may be included as part of the calibration of the auxiliary AF process of block 540 of method 500 illustrated in FIG. 4.

The method 800 begins at block 801. At block 805, the processor 205 obtains a candidate sample (also referred to simply as a “sample”) from a previously performed auxiliary AF process. The sample may include the starting lens position, the value measured by the auxiliary AF process, the final lens position, and a confidence level of the final lens position. Depending on the embodiment, the value measured by the auxiliary AF process may be a measured phase difference for PDAF or a measured distance for DCIAF or TOFAF. The estimated lens position may be determined from the value measured by the auxiliary AF process. Hereinafter, the method 800 will be described with reference to the estimated lens position being included in the sample; however, the value measured by the auxiliary AF process may be substituted for the estimated lens position depending on the implementation of the method 800. The samples may be maintained in a database stored in a memory 230. The samples stored in the database may include “participating” samples (e.g., samples currently used in the calibration of the auxiliary AF process) and “non-participating” samples (e.g., samples not currently used in the calibration of the auxiliary AF process). The confidence level of the final lens position may be determined based on measurements associated with the particular auxiliary AF process being implemented. For example, in PDAF, the confidence level may be determined based on horizontal details or noise. In DCIAF, the confidence level may be determined based on a number of detected corner points and the matching of the corner points between image. In TOFAF, the confidence level may be determined based on the amount of ambient light and the reflectance of a target object in the scene.

At block 810, the processor 205 determines whether the confidence level of the sample is greater than a threshold confidence level. When the confidence level of the sample is not greater than a threshold confidence level, the method 800 does not store the sample and returns to block 805. When the confidence level of the sample is greater than a threshold confidence level, the method proceeds to block 815, where the processor 205 determines whether the estimated lens position is within a threshold distance from the final lens position determined by the main AF process. When the estimated lens position is within the threshold distance from the final lens position, the method proceeds to block 820, where the processor 205 increases a rating associated with each of the participating samples.

When the estimated lens position is not within the threshold distance from the final lens position, the method proceeds to block 825, where the processor 205 determines whether the candidate sample would have improved the estimation of the estimated lens position (e.g., whether including the candidate sample in the participating samples would have resulted in the estimated lens position being closer to the final lens position). When the candidate sample would have improved the estimation, the method 800 proceeds to block 830, where the processor 205 qualifies the candidate sample. The qualification of the sample may include adding the candidate sample to the participating samples used in calibrating the auxiliary AF process. In one implementation, there may be a maximum number of participating samples, for example, a maximum of ten participating samples. At block 835, the processor 205 determines whether the qualification of the candidate sample generates any redundancies in the participating samples and removes and redundant sample(s) from the group of participating samples. If the qualification of the candidate sample increases the number of participating sample past the maximum number of participating samples, the processor 205 may select one of the participating samples to be removed. In one example, the processor 205 may determine which of the participating sample(s), when removed, would have improved the estimation, and the processor 205 may remove the determined participating sample(s) from the group of participating samples.

When the candidate sample would not have improved the estimation of the estimated lens position, the method 800 proceeds to block 840, where the processor 205 determines whether removing sample(s) from the participating samples would have improved the estimation of the estimated lens position. When removing sample(s) from the participating samples would not have improved the estimation of the estimated lens position, the method 800 proceeds to block 845, where the processor 205 reduces the rating of the participating samples. At block 850, the processor 205 removes samples having a rating below a threshold rating from the group of participating samples. At block 855, the processor 205 adds the candidate sample to the group of non-participating samples in the database.

When removing sample(s) from the participating samples would have improved the estimation of the estimated lens position, the method 800 proceeds to block 845, where the processor 205 reduces the rating(s) of the identified sample(s) (e.g., the samples whose removal would have improved the estimation of the estimated lens position). At block 855, the processor 205 increases the rating(s) of the remaining sample(s). The method ends at block 870.

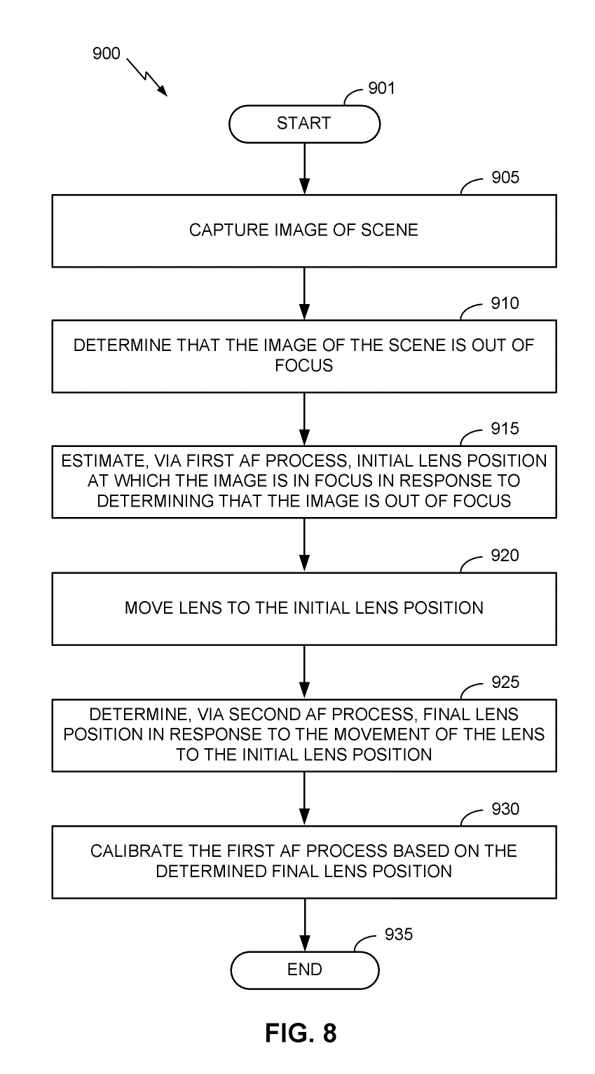

FIG. 8 is a flowchart illustrating another example method operable by an imaging device in accordance with aspects of this disclosure. The steps illustrated in FIG. 8 may be performed by an imaging device 200 or component(s) thereof. For example, the method 900 may be performed by a processor 205 of the imaging device 200. For convenience, the method 900 is described as performed by the processor 205 of the imaging device 200. The imaging device may include a lens 210.

The method 900 begins at block 901. At block 905, the processor 205 captures an image of a scene. At block 910, the processor 205 determines that the image of the scene is out of focus. At block 915, the processor 205 estimates, via a first AF process of a hybrid AF system, an initial lens position at which the image is in focus in response to determining that the image is out of focus. The first AF process may be an auxiliary AF process, for example, a TOFAF process, a PDAF process, or a DCIAF process. At block 920, the processor 205 moves the lens to the initial lens position. At block 925, the processor 205 determines, via a second AF process of the hybrid AF system, a final lens position in response to the movement of the lens to the initial lens position. The second AF process may be a main AF process, for example, a contrast AF process. At block 930, the processor 205 calibrates the first AF process based on the determined final lens position. The method ends at block 935.

### OTHER CONSIDERATIONS

In some embodiments, the circuits, processes, and systems discussed above may be utilized in a wireless communication device, such as apparatus 100. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, and a memory including instructions or modules for carrying out the processes discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may include random-access memory (RAM), read-only memory (ROM), electrically erasable programmable read-only memory (EEPROM), flash memory or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein include one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

1. A method, operable by an imaging device including a hybrid auto focus (AF) system comprising a lens and configured to perform at least one of a first AF process and a second AF process, the method comprising:
capturing an image of a scene;
determining that the image of the scene is out of focus;
estimating, via the first AF process of the hybrid AF system, an initial lens position at which the image is in focus in response to determining that the image is out of focus;
moving the lens to the initial lens position;
determining, via the second AF process of the hybrid AF system, a final lens position in response to the movement of the lens to the initial lens position; and
calibrating the first AF process based on the initial lens position and the determined final lens position.

2. The method of claim 1, wherein the first AF process is an auxiliary AF process and the second AF process is a main AF process, the first AF process being faster than the main AF process and the main AF process being more accurate than the auxiliary AF process.

3. The method of claim 1, wherein the second AF process comprises a contrast AF process and wherein the first AF process comprises one or more of: a time of flight AF (TOFAF) process, a phase detection AF (PDAF) process, a stereo AF (DCIAF) process, a structured light AF process, an ultrasound AF process, and a LIDAR AF process.

4. The method of claim 1, wherein the calibration of the first AF process comprises calculating a coefficient that relates a first AF process parameter to a lens position shift value.

5. The method of claim 4, wherein the calibration of the first AF process further comprises:
determining that the final lens position is not an outlier;
storing the final lens position in a memory in response to determining that the final lens position is not an outlier; and
updating the coefficient based on the final lens position in response to determining that the final lens position is not an outlier.

6. The method of claim 4, wherein the calibration of the first AF system process comprises:
determining that the final lens position in an outlier; and
refraining from updating the coefficient based on the final lens position in response to determining that the final lens position is an outlier.

7. The method of claim 4, further comprising maintaining a database of previous samples in the memory, each sample comprising a previously estimated first AF process parameter and a corresponding previously determined final lens position, wherein the calibration of the first AF process further comprises determining the coefficient based on the database of samples.

8. The method of claim 7, wherein the determining of the coefficient comprises:
removing outlying samples from the database;
selecting a subset of the samples from the database; and
determining the coefficient based on the selected subset of the samples.

9. The method of claim 4, further comprising maintaining a database of previous samples in the memory, each sample comprising a previously estimated first AF process parameter, wherein the calibration of the first AF process further comprises:
determining that removing one of the previous samples would have improved the estimation of the initial lens position;
removing the one of the previous samples from the database in response to determining that removing the one of the previous samples would have improved the estimation; and
updating the coefficient based on the remaining samples of the database.

10. The method of claim 4, further comprising:
determining a confidence level of the initial lens position;
determining that the confidence level is below a threshold confidence; and
refraining from updating the coefficient based on the final lens position in response to determining that the confidence level is below the threshold confidence.

11. An imaging device, comprising:
an image sensor;
a lens;
a hybrid auto focus (AF) system configured to perform a first AF process and a second AF process;
at least one processor; and
a memory storing computer-executable instructions for controlling the at least one processor to:
capture an image of a scene;
determine that the image of the scene is out of focus;
estimate, via the first AF process of the hybrid AF system, an initial lens position at which the image is in focus in response to determining that the image is out of focus;
move the lens to the initial lens position;
determine, via the second AF process of the hybrid AF system, a final lens position in response to the movement of the lens to the initial lens position; and
calibrate the first AF process based on the initial lens position and the determined final lens position.

12. The imaging device of claim 11, wherein the first AF process is an auxiliary AF process and the second AF process is a main AF process, the first AF process being faster than the main AF process and the main AF process being more accurate than the auxiliary AF process.

13. The imaging device of claim 11, wherein the second AF process comprises a contrast AF process and wherein the first AF process comprises one or more of: a time of flight AF (TOFAF) process, a phase detection AF (PDAF) process, a stereo AF (DCIAF) process, a structured light AF process, an ultrasound AF process, and a LIDAR AF process.

14. The imaging device of claim 11, wherein the computer-executable instructions are further for controlling the at least one processor to calculate a coefficient that relates a first AF process parameter to a lens position shift value.

15. The imaging device of claim 14, wherein the computer-executable instructions are further for controlling the at least one processor to:
determine that the final lens position is not an outlier;
store the final lens position in a memory in response to determining that the final lens position is not an outlier; and
update the coefficient based on the final lens position in response to determining that the final lens position is not an outlier.

16. The imaging device of claim 14, wherein the computer-executable instructions are further for controlling the at least one processor to:
determine that the final lens position in an outlier; and
refrain from updating the coefficient based on the final lens position in response to determining that the final lens position is an outlier.

17. The imaging device of claim 14, wherein the computer-executable instructions are further for controlling the at least one processor to maintain a database of previous samples in the memory, each sample comprising a previously estimated first AF process parameter and a corresponding previously determined final lens position, wherein the computer-executable instructions are further for controlling the at least one processor to determine the coefficient based on the database of samples.

18. The imaging device of claim 17, wherein the computer-executable instructions are further for controlling the at least one processor to:
remove outlying samples from the database;
select a subset of the samples from the database; and
determine the coefficient based on the selected subset of the samples.

19. The imaging device of claim 14, wherein the computer-executable instructions are further for controlling the at least one processor to:
maintain a database of previous samples in the memory, each sample comprising a previously estimated first AF process parameter:
determine that removing one of the previous samples would have improved the estimation of the initial lens position;
remove the one of the previous samples from the database in response to determining that removing the one of the previous samples would have improved the estimation; and
update the coefficient based on the remaining samples of the database.

20. The imaging device of claim 14, wherein the computer-executable instructions are further for controlling the at least one processor to:
determine a confidence level of the initial lens position;
determine that the confidence level is below a threshold confidence; and
refrain from updating the coefficient based on the final lens position in response to determining that the confidence level is below the threshold confidence.

21. An apparatus, comprising:
means for capturing an image of a scene;
means for determining that the image of the scene is out of focus;
means for estimating an initial lens position at which the image is in focus in response to determining that the image is out of focus;
means for moving the lens to the initial lens position;
means for determining a final lens position in response to the movement of the lens to the initial lens position; and
means for calibrating the means for estimating based on the initial lens position and the determined final lens position.

22. The apparatus of claim 21, wherein the means for estimating comprises means for performing an auxiliary AF process and the means for determining comprises means for performing a main AF process, the first AF process being faster than the main AF process and the main AF process being more accurate than the auxiliary AF process.

23. The apparatus of claim 21, wherein the means for determining comprises means for performing a contrast AF process and wherein the means for estimating comprises one or more of: means for performing a time of flight AF (TOFAF) process, means for performing a phase detection AF (PDAF) process, means for performing a stereo AF (DCIAF) process, means for performing a structured light AF process, means for performing an ultrasound AF process, and means for performing a LIDAR AF process.

24. The apparatus of claim 21, wherein the calibration of the means for estimating comprises means for calculating a coefficient that relates a first AF process parameter to a lens position shift value.

25. The apparatus of claim 24, wherein means for estimating further comprises:
means for determining that the final lens position is not an outlier;
means for storing the final lens position in a memory in response to determining that the final lens position is not an outlier; and
means for updating the coefficient based on the final lens position in response to determining that the final lens position is not an outlier.

26. A non-transitory computer readable storage medium having stored thereon instructions that, when executed, cause a processor of a device to:
capture an image of a scene;
determine that the image of the scene is out of focus;
estimate, via a first AF process of a hybrid AF system, an initial lens position at which the image is in focus in response to determining that the image is out of focus;
move the lens to the initial lens position;
determine, via a second AF process of the hybrid AF system, a final lens position in response to the movement of the lens to the initial lens position; and
calibrate the first AF process based on the initial lens position and the determined final lens position.

27. The non-transitory computer readable storage medium of claim 26, wherein the first AF process is an auxiliary AF process and the second AF process is a main AF process, the first AF process being faster than the main AF process and the main AF process being more accurate than the auxiliary AF process.

28. The non-transitory computer readable storage medium of claim 26, wherein the second AF process comprises a contrast AF process and wherein the first AF process comprises one or more of: a time of flight AF (TOFAF) process, a phase detection AF (PDAF) process, a stereo AF (DCIAF) process, a structured light AF process, an ultrasound AF process, and a LIDAR AF process.

29. The non-transitory computer readable storage medium of claim 26, further having stored thereon instructions that, when executed, cause the processor to calculate a coefficient that relates a first AF process parameter to a lens position shift value.

30. The non-transitory computer readable storage medium of claim 26, further having stored thereon instructions that, when executed, cause the processor to:
calculate a coefficient that relates a first AF process parameter to a lens position shift value;
determine that the final lens position is not an outlier;
store the final lens position in a memory in response to determining that the final lens position is not an outlier; and
update the coefficient based on the final lens position in response to determining that the final lens position is not an outlier.
